(19) United States
(12) Patent Application Publication
(10) Pub. No.: US 2026/0276079 A1
(43) Pub. Date: Sep. 17, 2026

(54) SHIFT DEVICE

(71) Applicant: KABUSHIKI KAISHA TOKAI-RIKA-DENKI-SEISAKUSHO, Niwa-gun, Aichi (JP)

(72) Inventor: Hiroki ONO, Niwa-gun, Aichi (JP)

(73) Assignee: KABUSHIKI KAISHA TOKAI-RIKA-DENKI-SEISAKUSHO, Niwa-gun, Aichi (JP)

(21) Appl. No.: 19/473,670

(22) PCT Filed: Apr. 5, 2024
(86) PCT No.: PCT/JP2024/014061

§ 371 Date: Oct. 8, 2025

(30) Foreign Application Priority Data
Apr. 21, 2023 (JP) 2023-070476

(51) Int. Cl. F16H 59/02

(52) U.S. Cl. CPC F16H 59/0278; F16H 2059/026; F16H 2059/0295

(57) ABSTRACT

A shift device includes: a shift body having a shaft body that is rotatably supported; plural projecting portions projecting out from the shaft body; and a mechanism portion provided at each of the plural projecting portions.

### TECHNICAL FIELD

The present disclosure relates to a shift device.

### BACKGROUND ART

There is known a shift device in which a shift body is structured so as to be rotatable (see, for example, Korean Patent No. 10-1976448).

In Korean Patent No. 10-1976448, one end of a shift body is joined to a rotation shaft, and the shift body is structured so as to be rotatable. The shift body includes a bullet that is anchored on an anchoring groove. The shift body is structured so as to return to a reference position due to the restoring force of the bullet.

By the way, it is preferable to make such a shift device compact.

### SUMMARY OF INVENTION

### Technical Problem

The present disclosure provides a shift device that can be made compact.

### Solution to Problem

A shift device of a first aspect of the present disclosure includes: a shift body having a shaft body that is rotatably supported; plural projecting portions projecting out from the shaft body; and a mechanism portion provided at each of the plural projecting portions.

In a shift device of a second aspect of the present disclosure, in the shift device of the first aspect of the present disclosure, one of the projecting portions is disposed at one side of the shaft body in a rotating direction of the shift body, and another of the projecting portions is disposed at another side of the shaft body in the rotating direction of the shift body.

In a shift device of a third aspect of the present disclosure, in the shift device of the first aspect or the second aspect of the present disclosure, one of the projecting portions and another of the projecting portions project out toward mutually opposite sides with the shaft body therebetween.

In a shift device of a fourth aspect of the present disclosure, in the shift device of any one of the first aspect through the third aspect of the present disclosure, the projecting portions project out in directions orthogonal to a vertical direction of the shift body.

In a shift device of a fifth aspect of the present disclosure, in the shift device of any one of the first aspect through the third aspect of the present disclosure, the projecting portions project out in a vertical direction of the shift body.

In a shift device of a sixth aspect of the present disclosure, in the shift device of any one of the first aspect through the fifth aspect of the present disclosure, the mechanism portion is an urging mechanism urging the shift body to a home position, a position detecting mechanism detecting a shift position of the shift body, or a locking mechanism locking rotation of the shift body.

### Advantageous Effects of Invention

In the shift device of the first aspect of the present disclosure, by providing the mechanism portions respectively at the plural projecting portions that project out from the shaft body, the mechanism portions are provided so as to project out from the shaft body. Therefore, as compared with a case in which the mechanism portions are not provided so as to project out from the shaft body, due to the mechanism portions being provided close to the shaft body, the size of the shift device in the height direction can be made to be small, and the shift device can be made to be compact. Alternatively, the mechanism portions are provided at the periphery of the shaft body in directions other than the direction extending from the shaft body to the operating portion of the shift body, and therefore, the size of the shift device in the transverse direction can be made to be small, and the shift device can be made to be compact.

In the shift device of the second aspect of the present disclosure, due to one of the projecting portions being disposed at one side of the shaft body and another of the projecting portions being disposed at another side of the shaft body in the rotating direction of the shift body, one mechanism portion is disposed at one side of the shaft body in the rotating direction of the shift body, and another mechanism portion is disposed at another side of the shaft body in the rotating direction of the shift body. Therefore, as compared with a case in which the one mechanism portion and the another mechanism portion are disposed at one side of the shaft body in the rotating direction of the shift body, the size of the shift device can be made to be small.

In the shift device of the third aspect of the present disclosure, due to the one projecting portion and the another projecting portion projecting out toward mutually opposite sides with the shaft body therebetween, the one mechanism portion and the another mechanism portion are disposed so as to face one another with the shaft body therebetween. Therefore, the size of the shift device can be made to be small as compared with a case in which the one mechanism portion and the another mechanism portion are not disposed so as to face one another with the shaft body therebetween.

In the shift device of the fourth aspect of the present disclosure, due to the projecting portions projecting out in directions orthogonal to the vertical direction of the shift body, the size of the shift device in the vertical direction of the shift body is made to be small. Therefore, the shift device can be made to be compact.

In the shift device of the fifth aspect of the present disclosure, due to the projecting portions projecting out in the vertical direction of the shift body, the size of the shift device in the rotating direction can be made to be small, and the shift device can be made to be compact.

In the shift device of the sixth aspect of the present disclosure, due to the mechanism portion being the urging mechanism, the position detecting mechanism or the locking mechanism, the shift device that includes the urging mechanism, the position detecting mechanism or the locking mechanism can be made to be compact.

### BRIEF DESCRIPTION OF DRAWINGS

FIG. 1 is a perspective view illustrating a shift device relating to an embodiment.

FIG. 2 is an exploded perspective view illustrating the shift device relating to the embodiment.

FIG. 3 is a cross-sectional view illustrating the shift device relating to the embodiment, and illustrates the A-A cross-section of FIG. 1.

FIG. 4 is a cross-sectional view illustrating the shift device relating to the embodiment, and illustrates a state in which a shift body is tilted forward.

FIG. 5 is a cross-sectional view illustrating a shift device relating to another embodiment.

FIG. 6 is a cross-sectional view illustrating a shift device relating to another embodiment.

### DESCRIPTION OF EMBODIMENTS

A shift device relating to an embodiment is described hereinafter with reference to the drawings. The embodiment describes an example in which a shift device 10 is a shift-by-wire type shift device for a vehicle. Note that, in the respective drawings, arrow D indicates a vertical direction D of a shift body, arrow E indicates a front-rear direction E of the shift device, and arrow F indicates a transverse direction F of the shift device.

### Structure of Shift Device

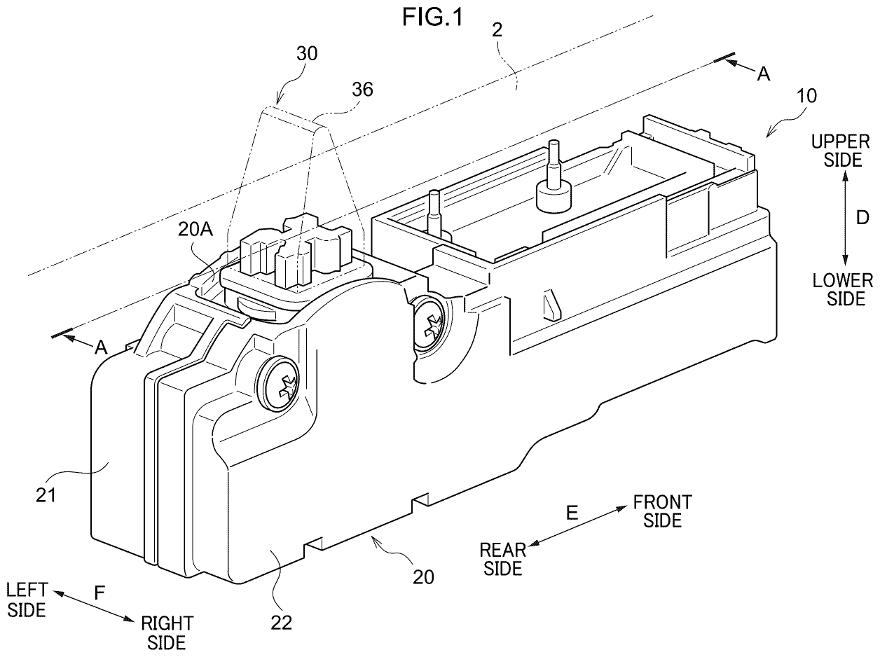

As illustrated in FIG. 1, the shift device 10 is, for example, disposed at a center console 2 provided between the driver's seat and the front passenger's seat within a vehicle passenger compartment. The shift position can be switched by the driver who is seated in the driver's seat operating the shift device 10.

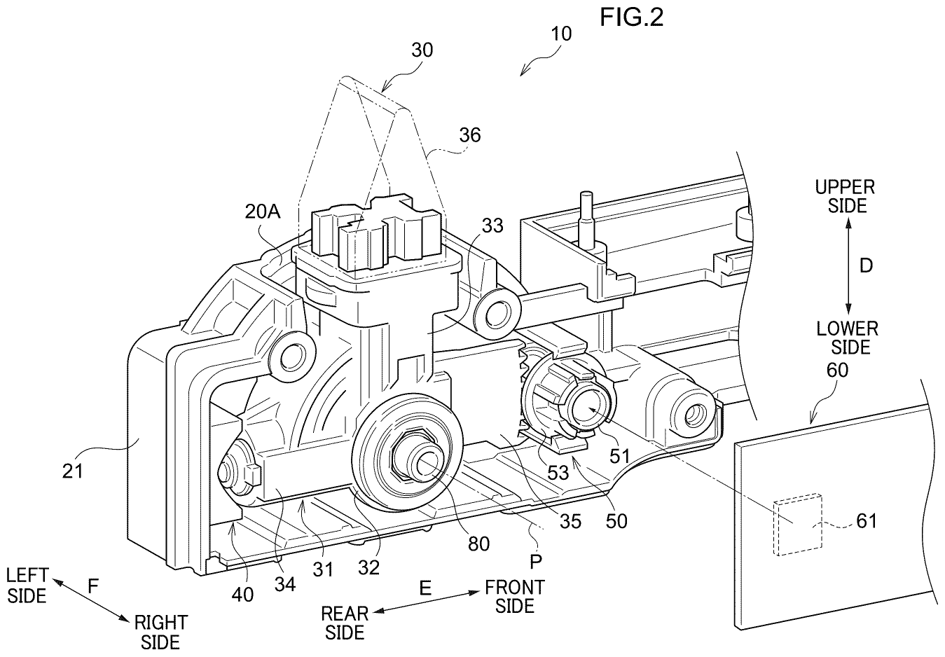

As illustrated in FIG. 1 and FIG. 2, the shift device 10 includes a housing 20, a shift body 30, an urging mechanism 40, a position detecting mechanism 50 and a sensor substrate 60.

### Housing 20

The housing 20 is formed in the shape of a rectangular box that extends in the front-rear direction E by a first housing 21 and a second housing 22. Opening portion 20A that opens upward is formed in the upper portion of the rear portion in the front-rear direction E of the housing 20. A knob 36 of the shift body 30 projects out to the exterior of the housing 20 from the opening portion 20A of the housing 20.

As illustrated in FIG. 2, a portion of the shift body 30, the urging mechanism 40, the position detecting mechanism 50 and the sensor substrate 60 are provided at the inner side of the housing 20.

### Shift Body 30

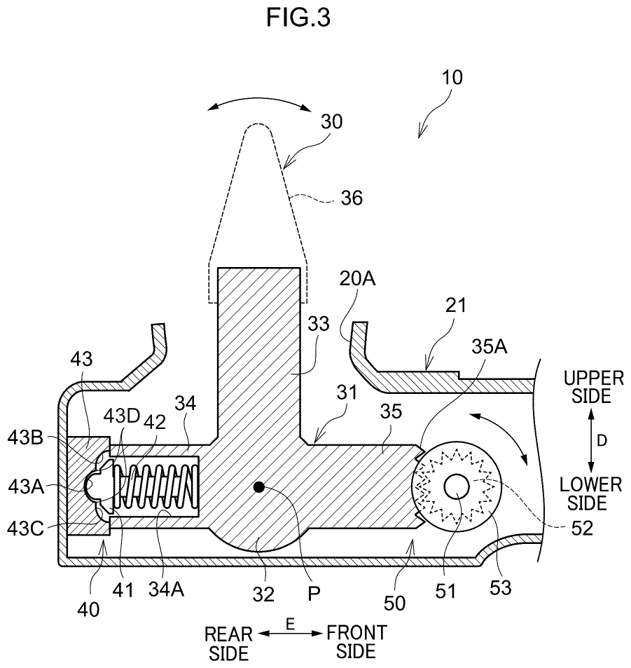

As illustrated in FIG. 2 and FIG. 3, the shift body 30 includes a main body portion 31 and the knob 36.

### Main Body Portion 31

The main body portion 31 includes a shaft body 32, a lever 33 provided so as to project out upward from the shaft body 32, a first projecting portion 34 provided so as to project out rearward from the shaft body 32, and a second projecting portion 35 provided so as to project out forward from the shaft body 32.

### Shaft Body 32

The shaft body 32 is formed in the shape of a cylinder that extends in the transverse direction F. The shaft body 32 is structured so as to be able to rotate with respect to supporting shaft 80 that is mounted to the housing 20. The shift body 30 can thereby rotate around rotation axis P that extends in the transverse direction F. In other words, the shift body 30 can rotate in the front-rear direction E.

### Lever 33

The lever 33 is formed in the shape of a pillar whose cross-section is substantially rectangular and that extends upward from the shaft body 32. The lever 33 passes-through the opening portion 20A of the housing 20. The knob 36 is provided at the distal end of the lever 33, and the knob 36 is exposed to the exterior of the housing 20.

### First Projecting Portion 34

The first projecting portion 34 is formed in the shape of a pillar whose cross-section is rectangular and that extends rearward from the shaft body 32. In the rotating direction of the shift body 30, the first projecting portion 34 is disposed at the rear side with respect to the shaft body 32. The first projecting portion 34 projects out in a direction orthogonal to the vertical direction D of the shift body 30. A hole 34A with a bottom, which extends in the front-rear direction E and has a bottom surface, is formed in the distal end surface (the rear end surface) of the first projecting portion 34. A click pin 41 and a click spring (compression coil spring) 42 are inserted in the hole 34A with a bottom.

The distal end surface (the rear end surface) of the click pin 41 is formed in a spherical shape. The click pin 41 is urged by the click spring 42 in a direction of projecting-out from the distal end surface of the first projecting portion 34.

An abutment member 43 that the distal end surface of the click pin 41 abuts is mounted to the housing 20. A first abutment hole 43A, a second abutment hole 43B provided above the first abutment hole 43A, and a third abutment hole 43C provided beneath the first abutment hole 43A are provided in the abutment member 43.

Click ridges 43D formed to project out forward are formed between the first abutment hole 43A and the second abutment hole 43B, and between the first abutment hole 43A and the third abutment hole 43C.

The click pin 41, the click spring 42 and the abutment member 43 structure the urging mechanism 40 that provides a clicking sensation to the operation of the shift body 30.

### Second Projecting Portion 35

The second projecting portion 35 is formed in the shape of a pillar whose cross-section is rectangular and that extends forward from the shaft body 32. In the rotating direction of the shift body 30, the second projecting portion 35 is disposed at the front side of the shaft body 32. The first projecting portion 34 and the second projecting portion 35 project out toward mutually opposite sides with the shaft body 32 therebetween. The second projecting portion 35 projects out in a direction orthogonal to the vertical direction D of the shift body 30. A gear 35A having plural teeth is formed in the distal end surface (the front end surface) of the second projecting portion 35.

A holder 53 that rotatably holds a magnet 51 is mounted to the housing 20. The magnet 51 is formed in a cylindrical shape for example, and different poles are magnetized in the peripheral direction. In other words, at the magnet 51, an N pole is magnetized at a radial direction one side, and an S pole is magnetized at the radial direction another side. A gear 52 having plural teeth is mounted to the magnet 51. The gear 35A of the second projecting portion 35 meshes together with the gear 52 mounted to the magnet 51. When the shift body 30 is operated, motive power is transmitted from the gear 35A to the gear 52, and the magnet 51 rotates.

### Sensor Substrate 60

As illustrated in FIG. 2, the sensor substrate 60 is disposed at the right side of the magnet 51 and is mounted to the housing 20. A magnet sensor 61 is provided at the sensor substrate 60. The magnet sensor 61 detects the shift position of the shift body 30 by detecting the direction of the magnetic field produced by the magnet 51.

The gear 35A, the magnet 51, the gear 52 and the magnet sensor 61 structure the position detecting mechanism 50 that detects the shift position of the shift body 30.

### Operation of Shift Device

As illustrated in FIG. 3, in the state in which the shift body 30 is at a home position, the distal end surface of the click pin 41 is fit with the first abutment hole 43A due to the urging force of the click spring 42.

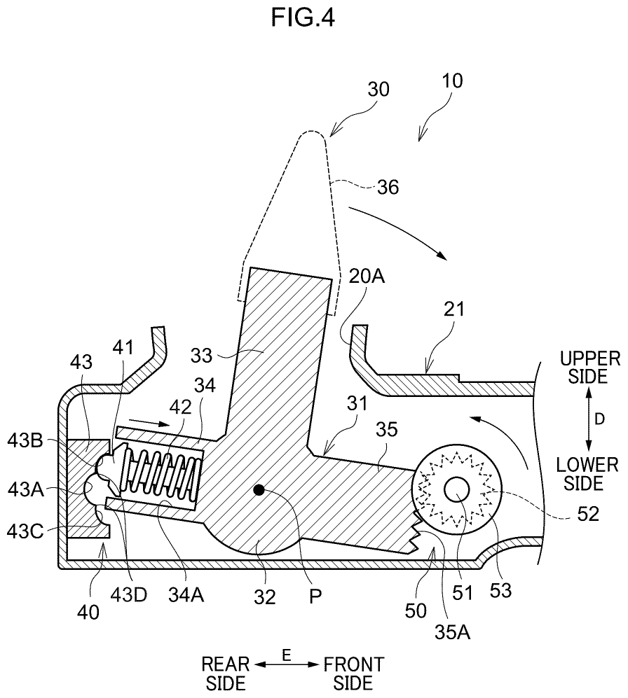

As illustrated in FIG. 4, when the knob 36 is operated and the shift body 30 is tilted forward from the home position, the first projecting portion 34 rotates upward with the rotation axis P being the center of rotation. At this time, the click pin 41 rides up over the click ridge 43D and moves into the second abutment hole 43B. Due to the click pin 41 riding up over the click ridge 43D, the operator of the shift body 30 can obtain a clicking sensation.

Further, when the knob 36 is operated and the shift body 30 is tilted forward from the home position, the second projecting portion 35 rotates downward with the rotation axis P being the center of rotation. At this time, the downward motive power of the second projecting portion 35 is transmitted to the gear 35A of the second projecting portion 35 and to the gear 52, and the magnet 51 rotates. Then, due to the magnet sensor 61 detecting the direction of the magnetic field produced by the magnet 51, the magnet sensor 61 detects the shift position of the shift body 30.

When the driver releases their hold on the knob 36, due to the urging force of the click spring 42, the first projecting portion 34 moves from the second abutment hole 43B to the first abutment hole 43A with the rotation axis P being the center of rotation, and the shift body 30 returns to the home position from the state of being tilted forward.

When the knob 36 is operated and the shift body 30 is tilted rearward from the home position, the first projecting portion 34 rotates downward with the rotation axis P being the center of rotation. At this time, the click pin 41 rides up over the click ridge 43D and moves into the third abutment hole 43C. Due to the click pin 41 riding up over the click ridge 43D, the operator of the shift body 30 can obtain a clicking sensation.

Further, when the knob 36 is operated and the shift body 30 is tilted rearward from the home position, the second projecting portion 35 rotates upward with the rotation axis P being the center of rotation. At this time, the upward motive power of the second projecting portion 35 is transmitted to the gear 35A of the second projecting portion 35 and to the gear 52, and the magnet 51 rotates. Then, due to the magnet sensor 61 detecting the direction of the magnetic field produced by the magnet 51, the magnet sensor 61 detects the shift position of the shift body 30.

When the driver releases their hold on the knob 36, due to the urging force of the click spring 42, the first projecting portion 34 moves from the third abutment hole 43C to the first abutment hole 43A with the rotation axis P being the center of rotation, and the shift body 30 returns to the home position from the state of being tilted rearward.

### Effects

The shift device 10 of the embodiment includes the shift body 30 having the shaft body 32 that is rotatably supported, the first projecting portion 34 and the second projecting portion 35 that project out from the shaft body 32, the urging mechanism 40 that is provided at the first projecting portion 34, and the position detecting mechanism 50 that is provided at the second projecting portion 35 (see FIG. 3).

By the way, if the urging mechanism 40 or the position detecting mechanism 50 is provided so as to project out from the lever 33 of the shift body 30, the urging mechanism 40 or the position detecting mechanism 50 is disposed far from the shaft body 32. Therefore, the size of the shift device 10 increases.

By providing the urging mechanism 40 provided at the first projecting portion 34 that projects out from the shaft body 32, and the position detecting mechanism 50 provided at the second projecting portion 35 that projects out from the shaft body 32, the urging mechanism 40 and the position detecting mechanism 50 are provided as to project out from the shaft body 32.

Therefore, as compared with a case in which the urging mechanism 40 and the position detecting mechanism 50 are not provided as to project out from the shaft body 32, the urging mechanism 40 and the position detecting mechanism 50 are provided near the shaft body 32. As a result, the size of the shift device 10 in the height direction can be made to be small, and the shift device 10 can be made to be compact. Further, because the urging mechanism 40 and the position detecting mechanism 50 are provided at the periphery of the shaft body 32 in the rotating direction thereof other than at the lever 33, the size of the shift device 10 in the transverse direction F can be made to be small, and the shift device 10 can be made to be compact.

Further, the regions over which the urging mechanism 40 and the position detecting mechanism 50 can move are made to be narrow as compared with a case in which the urging mechanism 40 and the position detecting mechanism 50 are not provided so as to project out from the shaft body 32. As a result, the size of the shift device 10 in the front-rear direction E can be made to be small, and the shift device 10 can be made to be compact.

In the shift device 10 of the embodiment, the first projecting portion 34 is disposed at the rear side of the shaft body 32 in the rotating direction of the shift body 30, and the second projecting portion 35 is disposed at the front side of the shaft body 32 in the rotating direction of the shift body 30 (see FIG. 3).

By disposing the first projecting portion 34 at the rear side of the shaft body 32 and the second projecting portion 35 at the front side of the shaft body 32 in the rotating direction of the shift body 30, the urging mechanism 40 is disposed at the rear side of the shaft body 32 in the rotating direction of the shift body 30, and the position detecting mechanism 50 is disposed at the front side of the shaft body 32 in the rotating direction of the shift body 30. Therefore, the size of the shift device 10 can be made to be small as compared with a case in which the urging mechanism 40 and the position detecting mechanism 50 are disposed at one side of the shaft body 32 in the rotating direction of the shift body 30.

In the shift device 10 of the embodiment, the first projecting portion 34 and the second projecting portion 35 project out toward mutually opposite sides with the shaft body 32 therebetween (see FIG. 3).

Due to the first projecting portion 34 and the second projecting portion 35 projecting out toward mutually opposite sides with the shaft body 32 therebetween, the urging mechanism 40 and the position detecting mechanism 50 are disposed so as to face one another with the shaft body 32 therebetween. Therefore, the size of the shift device 10 can be made to be small as compared with a case in which the urging mechanism 40 and the position detecting mechanism 50 are not disposed so as to face one another with the shaft body 32 therebetween.

In the shift device 10 of the embodiment, the first projecting portion 34 and the second projecting portion 35 project out in directions orthogonal to the vertical direction D of the shift body 30 (see FIG. 3).

Due to the first projecting portion 34 and the second projecting portion 35 projecting out in directions orthogonal to the vertical direction D of the shift body 30, the size of the shift device 10 in the vertical direction D of the shift body 30 can be made to be small. Therefore, the shift device 10 can be made to be compact.

In the shift device of the embodiment, the mechanism portions are the urging mechanism 40 that urges the shift body 30 to the home position, and the position detecting mechanism 50 that detects the shift position of the shift body 30 (see FIG. 3).

Due to the mechanism portions being the urging mechanism 40 and the position detecting mechanism 50, the shift device 10 that includes the urging mechanism 40 and the position detecting mechanism 50 can be made to be compact.

The shift device of the present disclosure has been described above on the basis of the above-described embodiment. However, the specific structure is not limited to this embodiment, and changes in design and the like are permitted provided that they do not depart from the gist of the inventions relating to the respective claims of the Claims.

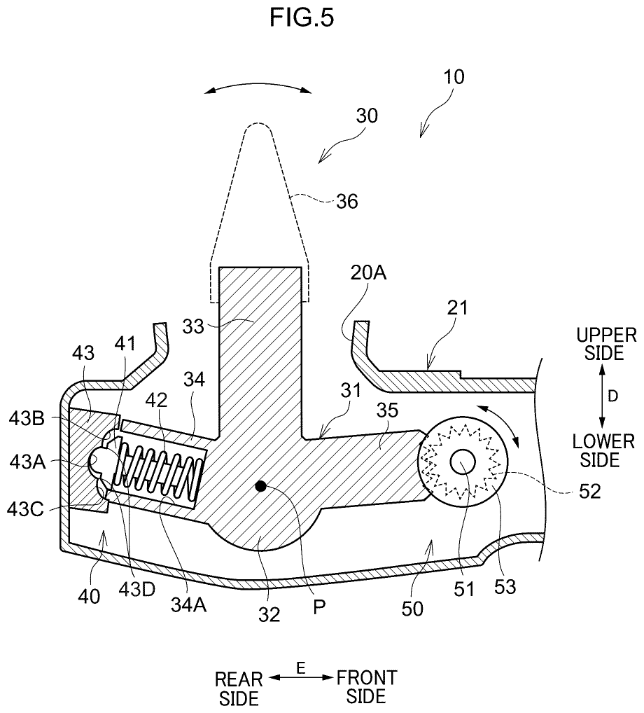

The above embodiment illustrates an example in which the first projecting portion 34 and the second projecting portion 35 project out toward mutually opposite sides with the shaft body 32 therebetween. However, as illustrated in FIG. 5, the first projecting portion 34 may be formed so as to extend at an upward and rearward incline from the shaft body 32, and the second projecting portion 35 may be formed so as to extend at an upward and forward incline from the shaft body 32.

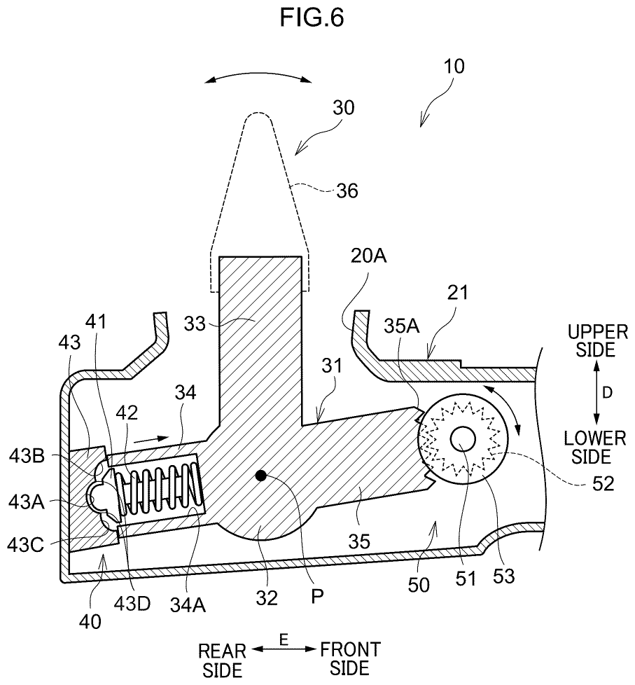

The above embodiment illustrates an example in which the first projecting portion 34 and the second projecting portion 35 project out in directions orthogonal to the vertical direction D of the shift body 30. However, as illustrated in FIG. 6, the first projecting portion 34 and the second projecting portion 35 may project out in a direction that is inclined with respect to a direction orthogonal to the vertical direction D of the shift body 30.

The above embodiment illustrates an example in which the first projecting portion 34 and the second projecting portion 35 project out in directions orthogonal to the vertical direction D of the shift body 30. However, the first projecting portion and the second projecting portion may project out downward from the shaft body, or may project out upward from the shaft body.

The above embodiment illustrates an example in which the two projecting portions that are the first projecting portion 34 and the second projecting portion 35 are provided as the projecting portions that project out from the shaft body 32. However, three or more of the projecting portions that project out from the shaft body may be provided.

The above embodiment illustrates an example in which the mechanism portions are the urging mechanism 40 and the position detecting mechanism 50. However, the mechanism portions can be made to be mechanisms that relate to operation of the shift body, and may be, for example, a locking mechanism that locks operation of the shift body. In this case, a locking member that locks operation of the shift body may be moved in the rotating axis direction of the shift body and lock the operation of the shift body.

The above embodiment illustrates an example in which the shift device 10 is a momentary-type shift device in which the shift body 30 returns to the home position by itself when the driver releases their hold on the knob 36. However, the shift device can also be made to be a stationary-type shift device in which the shift body 30 is maintained at the shift position due to the knob being operated.

The above embodiment illustrates an example in which the holder 53 that holds the magnet 51 rotatably is mounted to the housing 20. However, the magnet may be provided at the second projecting portion.

The above embodiment illustrates an example in which the shift device 10 is disposed at the center console 2. However, the shift device can be disposed at another part within the vehicle passenger compartment such as the instrument panel, the column cover, or a door trim.

The disclosure of Japanese Patent Application No. 2023-070476 filed on Apr. 21, 2023 is, in its entirety, incorporated by reference into the present specification.

All publications, patent applications, and technical standards mentioned in the present specification are incorporated by reference into the present specification to the same extent as if such individual publication, patent application, or technical standard was specifically and individually indicated to be incorporated by reference.

1. A shift device, comprising:
a shift body having a shaft body that is rotatably supported;
a plurality of projecting portions projecting out from the shaft body; and
a mechanism portion provided at each of the plurality of projecting portions.

2. The shift device of claim 1, wherein:
one of the projecting portions is disposed at one side of the shaft body in a rotating direction of the shift body, and
another of the projecting portions is disposed at another side of the shaft body in the rotating direction of the shift body.

3. The shift device of claim 1, wherein one of the projecting portions and another of the projecting portions project out toward mutually opposite sides with the shaft body therebetween.

4. The shift device of claim 1, wherein the projecting portions project out in directions orthogonal to a vertical direction of the shift body.

5. The shift device of claim 1, wherein the projecting portions project out in a vertical direction of the shift body.

6. The shift device of claim 1, wherein the mechanism portion is:
an urging mechanism urging the shift body to a home position,
a position detecting mechanism detecting a shift position of the shift body, or
a locking mechanism locking rotation of the shift body.
